(19) United States
(12) Patent Application Publication
(10) Pub. No.: US 2005/0275762 A1
(43) Pub. Date: Dec. 15, 2005

(54) Liquid crystal on silicon display device

(75) Inventors: Chia-Te Lin, Lioujiao Township (TW); Da-Shuang Kuan, Cyonglin Township (TW)

Correspondence Address: J C PATENTS, INC., 4 VENTURE, SUITE 250, IRVINE, CA, 92618, US

(73) Assignee: UNITED MICROELECTRONICS CORP.

(21) Appl. No.: 10/865,589

(22) Filed: Jun. 9, 2004

(51) Int. Cl. G02F 1/1335

(52) U.S. Cl. 349/5

(57) ABSTRACT

A liquid crystal on silicon (LCOS) display device using white light of light emitting diode (LED) as light source is provided. The LCOS display device comprises a white light source, a color separation and polarization device, and a LCOS panel device. The white light source is provided for emitting a white light. The color separation and polarization device is disposed on a light path of the white light, and adapted for separating and polarizing the white light to obtain a plurality of polarized monochromatic lights. The LCOS panel device is disposed on a light path of the polarized monochromatic lights, and the polarized monochromatic lights are partially polarized according to an inputted image signal. Thereafter, the partially polarized monochromatic lights are combined to obtain an output image signal.

### BACKGROUND OF THE INVENTION

1. Field of the Invention

The present invention generally relates to a liquid crystal on silicon (LCOS) display device. More particularly, the present invention relates to a LCOS display device using a white light or a plurality of monochromatic light emitting diodes (LED) as a light source.

2. Description of Related Art

In recently years, since the liquid crystal display (LCD) has the advantages being compact, flat, light weight, low operation voltage, low power consumption and radiation free, the conventional cathode ray tube (CRT) has been gradually replaced, and the LCD has become the main stream of display device. However, since the limitation of LCD device, the size of the display screen of LCD is generally lower than 30 inches. Conventionally, the plasma display panel (PDP) is developed for the display device having a screen size between 30 inches and 60 inches. However, the cost of plasma display panel (PDP) is too high to be attractive to the consumer.

Therefore, recently a large size display device has been developed using projection technology. Conventionally, the projection device may be classified into reflective projection display device and rear projection display device. The reflective projection display device includes, such as liquid crystal projector (LCP), digital light processing (DLP) projector and liquid crystal on silicon (LCOS). In development of the rear projection display device, the liquid crystal on silicon (LCOS) projection technology is used. Recently, the projection display device available on the market includes liquid crystal projector (LCP) and digital light processing (DLP) projector. Since the liquid crystal on silicon (LCOS) projection technology has the advantages of low-cost, high aperture ratio (up to 90%), high resolution (the interval between pixels may be 12 μm or less), and therefore several manufacturers are developing the LCOS.

It is noted that, the LCOS projection technology is the key technology of developing the reflecting projection display device and the rear projection display device due to low cost and high resolution.

FIG. 1 is a drawing schematically illustrating a conventional LCOS projection device. Referring to FIG. 1, in the LCOS projection device, a white light 104 is emitted from the light source 102. The white light 104 is separated into red light 112, green light 122 and blue light 142 via the filter 106 and the color separation lens 108. The red light 112 is reflected into the polarization beam splitter (PBS) 116 after passing through the color separation mirror (or called a dichroic mirror) 110 and the reflection mirror 114.

FIG. 2 and FIG. 3 schematically illustrate the function of the conventional polarization beam splitter (PBS). For example, when the red light 112 passes through the polarization beam splitter (PBS) 116 in front of the LCOS panel 118, only a light having a specific polarization direction is reflected into the LCOS panel 118 by the polarization beam splitter (PBS) 116. For example, only the S-polarized light of the red light 112 is incident to the LCOS panel 118 via the polarization beam splitter (PBS) 116. Referring to FIG. 2, when the image to be displayed by the LCOS panel 118 is dark, the S-polarized light incident to the LCOS panel 118 will be reflected and can not be incident to, for example, the optical combiner prism (or called X-Cube) 152 shown in FIG. 1. Alternatively, referring to FIG. 3, when the image to be displayed by the LCOS panel 118 is bright, the S-polarized light incident to the LCOS panel 118 will be changed into P-polarized light 120 by the LCOS panel 118 and can pass the polarization beam splitter (PBS) 116 and be incident to, for example, the optical combiner prism 152 shown in FIG. 1.

Referring to FIG. 1, the red light 112, the green light 122 and the blue light 142 are reflected to the LCOS panels 118, 132 and 146 via the polarization beam splitters (PBS) 116, 130 and 144 respectively. Then, a portion of the red light (or green light and blue light) having image (the image to be displayed is bright) is partially polarized by each of the LCOS panel respectively. Thereafter, the partially polarized red light 120, the partially polarized green light 134 and the partially polarized blue light 148 are combined by the optical combiner prism (or called X-cube) 152 to obtain an image signal. Then, the image signal is projected to the display screen via the lens set 154.

Recently, in the conventional LCOS projection device, the beam splitter could be beam splitter prism, dichroic mirror or dichroic filter. As shown in FIG. 1, the optical combiner prism 152 may be used as a beam splitter prism when the direction of light propagation is opposite. The color separation mirror 110 shown in FIG. 1 can be a color separation mirror or a color separation filter. Further, the LCOS projection device shown in FIG. 1 is generally called an on-axial projection device since the light path of the propagation of the light is parallel to the normal of the reflection plane of the beam splitter components.

FIG. 4 schematically illustrates an off-axial LCOS projection device. Referring to FIG. 4, in the off-axial LCOS projection device, a white light is emitted from the light source 402. The white light is separated into red light 406, green light 408 and blue light 410 via the color separation mirror 404. The three primary color lights are polarized by the polarizer 412 and are incident to the LCOS panel 414. The red light, the green light and the blue light having images are partially polarized by the LCOS panel 414. Then, the partially polarized red, green and blue lights are combined by the analyzer 416 and the optical combiner prism 418 to obtain an image signal. Then, the image signal is projected to the display screen.

It is noted that, in the on-axial or off-axial LCOS projection device described above, the light source 102 or 402 is generally constructed by an arc lamp, a halogen lamp or metal-halide lamp. In general, the disadvantages of the conventional light source described above are that the light emitted from the light source includes infrared (IR) light and ultraviolet (UV) light except for visible light. Therefore, filters are required to filter out the infrared light and ultraviolet light. However, the infrared light will generate a lot of heat and thus a heat sink device is required. In addition, the light path is influenced by the thermal expansion of the optical component or the deformation of the optical component, and thus the image quality is reduced. Moreover, the power consumption is high as a lot of electric energy is converted into thermal energy. Therefore, a light source with low heat, low power consumption, non-infrared light and non-ultraviolet light is highly desirable.

### SUMMARY OF THE INVENTION

Accordingly, the present invention is directed to a liquid crystal on silicon (LCOS) display device, wherein the light source of the LCOS display device has the advantages of low heat and low power consumption.

The LCOS display device, according to an embodiment of the present invention, comprises, for example but not limited to, a white light source, a color separation and polarization device, and a LCOS panel device. The white light source is adapted for emitting a white light. The color separation and polarization device is disposed on a light path of the white light and is adapted for separating and polarizing the white light to obtain a plurality of polarized monochromatic lights. The LCOS panel device is disposed on a light path of the polarized monochromatic lights, and the polarized monochromatic lights are partially polarized according to an inputted image signal. Thereafter, the partially polarized monochromatic lights are combined to obtain an output image signal.

In one embodiment of the present invention, the color separation and polarization device comprises a color separation device and a polarization device. Moreover, in another embodiment of the present invention, the color separation device is disposed on the light path of the white light and adapted for separating the white light into a plurality of monochromatic lights, and the polarization device is disposed on a light path of the monochromatic lights and adapted for polarizing each of the monochromatic lights to obtain a plurality of polarized monochromatic light. Alternatively, in still another embodiment of the present invention, the polarization device is disposed on the light path of the white light and adapted for polarizing the white light, and the color separation device is disposed on a light path of the polarized white light and adapted for separating the polarized white light into a plurality of polarized monochromatic light.

In one embodiment of the present invention, an amount of each of the polarized monochromatic lights that are partial polarized is related to a gray scale of the inputted image signal.

In one embodiment of the present invention, the color separation device comprises color wheel.

In one embodiment of the present invention, each of the monochromatic lights comprises one of three primary color lights. In another embodiment of the present invention, the monochromatic lights comprise three primary color lights and another white light.

In one embodiment of the present invention, the LCOS panel comprises one LCOS panel, two LCOS panels, three LCOS panels, four or more than four LCOS panels. Moreover, in another embodiment of the present invention, the color separation and polarization device comprises at least one color separation device and at least one polarization device. A number of the color separation device and a number of the polarization device is dependent on a type of the LCOS panel device.

In one embodiment of the present invention, the LCOS display device comprises an on-axial LCOS display device or off-axial LCOS display device.

In one embodiment of the present invention, the white light source comprises, for example but not limited to, a white light light-emitting-diode (LED) light source, a combination of a plurality of monochromatic LED light sources, a combination of three primary color LED light sources, or a combination of a blue light LED and a yellow fluorescent dye.

In addition, the invention provides a liquid crystal on silicon (LCOS) display device. The LCOS display device comprises, for example but not limited to, a plurality of monochromatic LED light sources, a plurality of polarization devices, a plurality of LCOS panels, and an optical combiner device. The monochromatic LED light sources are adapted for emitting a plurality of monochromatic lights. Each of the polarization devices is disposed on a light path of the monochromatic light respectively. The polarization devices are adapted for polarizing each of the monochromatic lights to obtain a plurality of polarized monochromatic lights. Each of the LCOS panels is disposed on a light path of the polarized monochromatic lights respectively. The polarized monochromatic lights are partially polarized according to an inputted image signal. The optical combiner device is adapted for combining the partially polarized monochromatic lights to obtain an output image signal.

In one embodiment of the present invention, an amount of each of the partially polarized monochromatic lights is related to a gray scale of the inputted image signal.

In one embodiment of the present invention, each of the monochromatic lights comprises one of three primary color lights. In another embodiment of the present invention, the monochromatic lights comprise three primary color lights and a white light.

In one embodiment of the present invention, the LCOS panels comprise one LCOS panel, two LCOS panels, three LCOS panels, four or more than four LCOS panels.

In one embodiment of the present invention, the LCOS display device comprises an on-axial LCOS display device. In another embodiment of the present invention, the LCOS display device comprises an off-axial LCOS display device.

Accordingly, the white light source generation device, according to an embodiment of the present invention, has the advantages of low heat and low power consumption, and is suitable for any LCOS display device such as single-panel, two-panel, three-panel, four-panel or other multi-panel LCOS display device. It is noted that, in the single-panel LCOS display device of the present invention, only one LCOS panel and one polarization device is required. However, in the conventional LCOS display device, three LCOS panels, three polarization beam splitter and one optical combiner prism (X-cube) are required. Therefore, single-panel LCOS display device, according to an embodiment of the present invention, further has the advantages of low cost, small size, light weight and high definition. In addition, the white light source generation device according to an embodiment of the present invention is suitable for any LCOS display device such as on-axial or off-axial LCOS display device.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The following drawings illustrate embodiments of the invention and, together with the description, serve to explain the principles of the invention.

FIG. 1 schematically illustrates a conventional LCOS projection device.

FIG. 2 and FIG. 3 schematically illustrate the function of the conventional polarization beam splitter (PBS).

FIG. 4 schematically illustrates an off-axial LCOS projection device.

FIG. 5A schematically illustrates a LCOS display device according to one embodiment of the present invention.

FIG. 5B and FIG. 5C schematically illustrate the function of a polarization beam splitter (PBS) according to one embodiment of the present invention.

FIG. 6 schematically illustrates a color separation device according to one embodiment of the present invention.

FIG. 7 schematically illustrates a white light source according to one embodiment of the present invention.

### DESCRIPTION OF THE EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

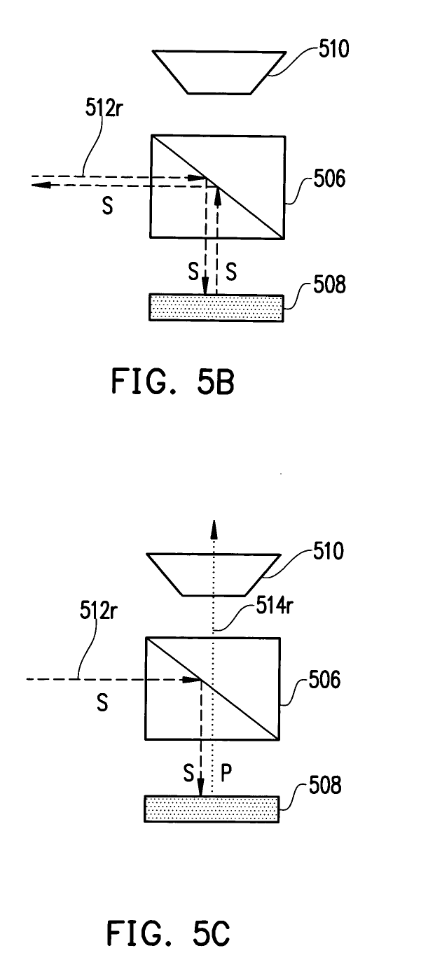

FIG. 5A schematically illustrates a LCOS display device according to one embodiment of the present invention. Referring to FIG. 5A, a LCOS display device 500 comprises, for example but not limited to, a white light source 502, a color separation device 504a or 504b, a polarization device 506 and a LCOS panel 508. The color separation device 504a or 504b is adapted for separating the white light into a plurality of monochromatic lights. The polarization device 506 is adapted for polarizing each monochromatic light. In another embodiment of the present invention, the LCOS display device further comprises a lens 510. Referring to FIG. 5A, a white light 512 is emitted by the white light source 502. The white light source 502 comprises, for example but not limited to, a white light LED. In one embodiment of the invention, the color separation device 504a or 504b comprises, for example but not limited to, a color wheel to separate the white light 512 into, for example, three primary color lights such as red light, green light and blue light. The color separation device can be disposed between the white light source 502 and polarization device 506 such as color separation device 504a. Or, color separation device can be disposed between the polarization device 506 and the LCOS panel 508 such as color separation device 504b. The color separation device 504a or 504b and the polarization device 506 may be included in a color separation and polarization device. The polarization device 506 comprises, for example but not limited to, a polarizer such as polarization beam splitter (PBS).

FIG. 5B and FIG. 5C schematically illustrate the function of a polarization beam splitter (PBS) according to one embodiment of the present invention. In the present embodiment, the incidence light is, for example but not limited to, a red light. First, a red light 512r is separated from the white light 512 via the color separation device 504a. Then, only a portion of the red light 512r having a specific polarization direction is incident to the LCOS panel 508 after the red light 512r passes through the polarization device 506. For example but not limited to, only S-polarized light of the red light is incident to the LCOS panel 508. Referring to FIG. 5B, when the image to be displayed on the LCOS panel 508 is dark, the S-polarized light incident to the LCOS panel 508 is reflected by the polarization beam splitter 506 and thus can not be incident to the lens 510. Thereafter, referring to FIG. 5C, when the image to be displayed on the LCOS panel 508 is bright, the S-polarized light incident to the LCOS panel 508 is changed into P-polarized light 514r. Therefore, the light 514r can be incident to the lens 510 via the polarization device 506. The amount of the S-polarized light changing into P-polarized light is dependent on the gray scale of the image to be displayed on the LCOS panel 508. In addition, the green light and blue light separated from the white light 512 via the color separation device 504a or 504b is performed by the same process as described above.

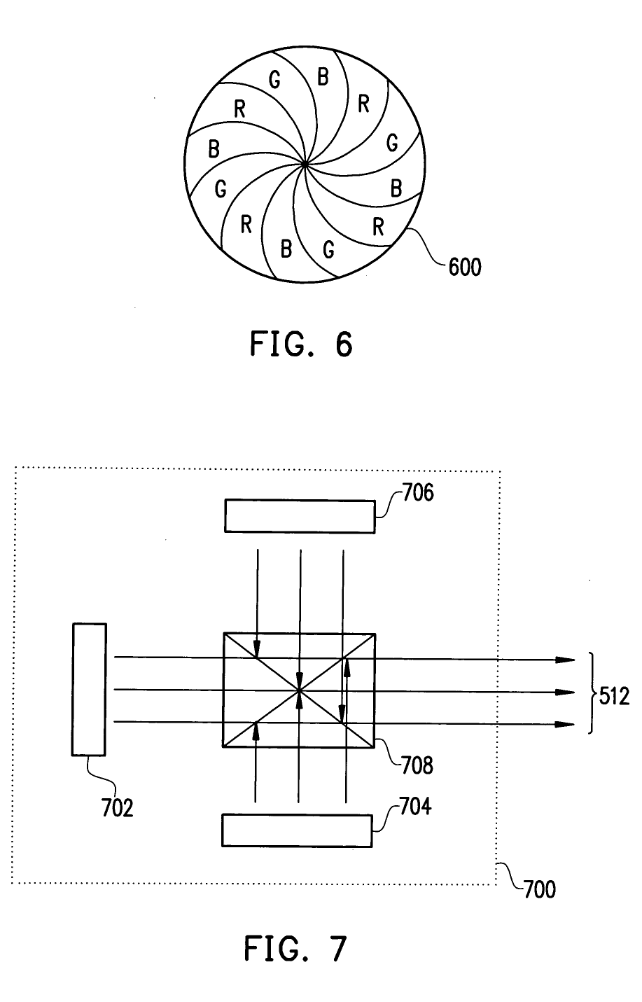

FIG. 6 schematically illustrates a color separation device according to one embodiment of the present invention. Referring to FIG. 6, the color separation device 600 comprises, for example but not limited to, a color wheel 600 having a plurality of red (R), green (G) and blue (B) filters. The white light is separated into red light, green light or blue light by the color wheel. The color wheel 600 is rotated in a predetermined speed, and for example, when the white light passes the red light filter R, the white light is filtered to a red light. In another embodiment of the present invention, the color wheel comprises, for example but not limited to, a plurality of red light, green light, blue light and white light filters. The white light filter is used to provide a white light to enhance the background brightness of the frame of image. It is noted that, in the embodiment shown in FIG. 6 is only provided for description purpose and should not be used to limit the range of the present invention.

In one embodiment of the present invention, the white light source 502 comprises, for example but not limited to, a plurality of monochromatic LED chips wherein the white light can be generated by adjusting the current via each monochromatic LED chip. The monochromatic LED chips comprise, for example but not limited to, red light, blue light and green light LED chips for providing a three-wavelength type white light LED, or yellow light and blue light LED chips for providing two-wavelength type white light LED.

In one embodiment of the present invention, the white light source 502 is constructed by, for example but not limited to, a blue light LED chip incorporated with a yellow inorganic fluorescent powder (or yellow organic fluorescence dye) to generate white light. The wavelength of the blue light emitted from the blue light LED chip is in a range between, for example but not limited to, 440 nm and 490 nm. Thereafter, the yellow inorganic fluorescent powder is irradiated by the blue light to generate a yellow fluorescence. After the yellow fluorescence and the residual blue light are mixed, a white light is generated. The white light LED described in the embodiment is only provided for description and should not be used to limit the scope of the present invention.

FIG. 7 schematically illustrates a white light source according to one embodiment of the present invention. The white light source 502 shown in FIG. 5A can be constructed by, for example but not limited to, using the white light source shown in FIG. 7. Referring to FIG. 7, the white light source 700 comprises, for example but not limited to, a red light LED 702, a green light LED 704, a blue light LED 706 and an optical combiner prism 708. The three monochromatic lights are combined into a white light 512 via the optical combiner prism 708. The optical combiner prism 708 comprises, for example but not limited to, a X-cube 708. The white light source 700 is only provided for description and could not be used to limit the scope of the present invention.

The LCOS display device shown in FIG. 5A is generally called as a single-panel LCOS display device since only one LCOS panel is required in the LCOS display device. However, in the conventional LCOS display device, at least three LCOS panels, three polarizers and one optical combiner prism (or X-cube) are required. Therefore, the cost of the LCOS display device of the present invention is substantially lower compared to the conventional LCOS display device and also can be substantially smaller, lighter and thinner compared to the conventional LCOS display device. In addition, in the single-panel LCOS display device of one embodiment of the invention comprising a single polarizing device, the light path of the three primary color lights (or the three primary color lights and the white light) is not distorted regardless of thermal expansion or deformation of the polarizing device. Thus, the image quality of the single-panel LCOS display device is better than that of the conventional LCOS display device in which at least three polarizing devices are utilized and thermal expansion or deformation thereof could easily distort the light path.

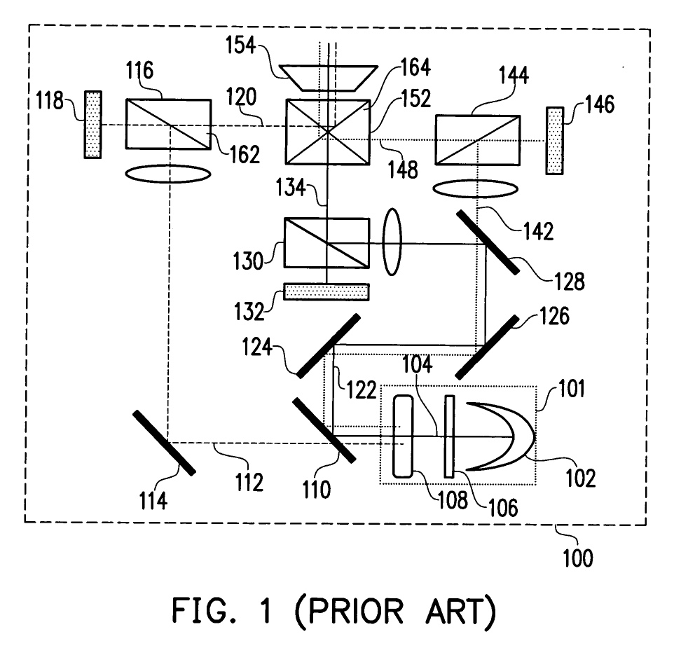

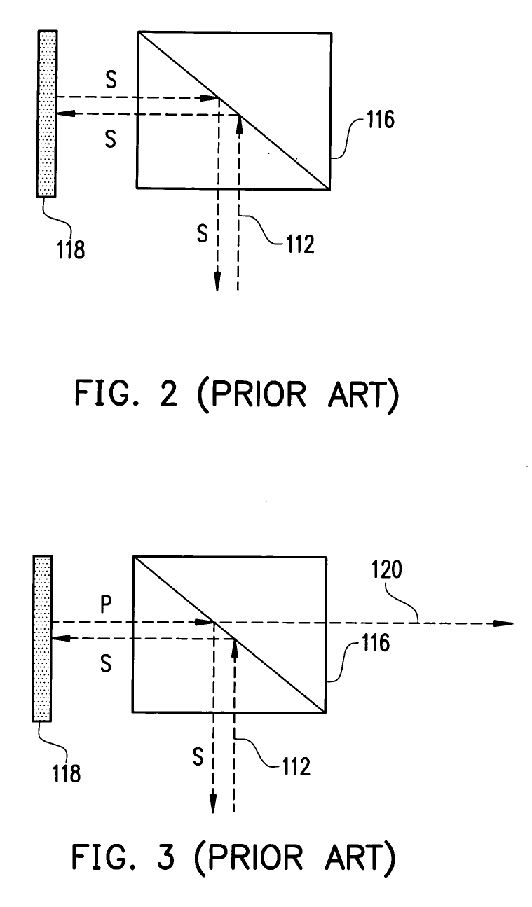

In one embodiment of the present invention, a LCOS display device can be constructed by replacing the light source set 101 of the LCOS display device shown in FIG. 1 to the white light source 502 described above. In other words, in the LCOS display device according to another embodiment, the components of the LCOS display device shown in FIG. 1 are same except for the light source set 101. Thus, a three-panel LCOS display device can be constructed to achieve the purpose of the present invention.

In one embodiment of the present invention, one of the LCOS panel and the polarization beam splitter (PBS) shown in FIG. 1 could be omitted. In the present embodiment, first of all, the white light is separated into two monochromatic lights such as a yellow light and a blue light respectively. Then, the two monochromatic lights are partially polarized and combined via the optical combiner prism. In another embodiment of the present invention, another beam splitter device such as a color wheel may be disposed between the LCOS panel and the polarization device (for example, in the light path of the yellow light) so that the yellow light can be separated into a red light and a green light.

In one embodiment of the present invention, an external LCOS panel and an external polarization device could be added to the LCOS display device shown in FIG. 1. Thus, the white light can be separated into three primary color lights (for example, red light, green light and blue light) and another white light respectively. Then, the three primary color lights and the white light are partial polarized and combined via the optical combiner prism.

In an alternative embodiment of the present invention, the light source set 101 could be replaced by three LED light sources for generating lights 112, 122 and 142 disposed before the corresponding polarization beam splitters 116, 130 and 144, and the other components of the LCOS display device shown in FIG. 1 are the same except for the light source set 101. In another embodiment of the present invention, a two-panel LCOS display device of the present invention can be constructed by using two monochromatic LED light source and two LCOS panels. In still another embodiment of the present invention, a four-panel LCOS display device can be constructed by using three monochromatic LED light sources and one white light source combined thereof or four monochromatic LED light sources and four LCOS panels.

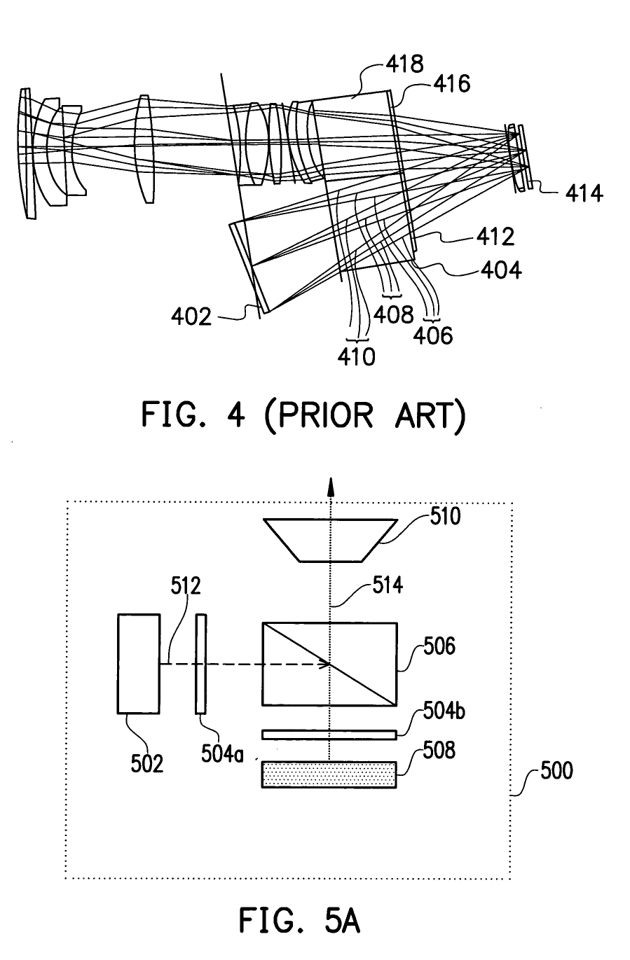

In one embodiment of the present invention, an off-axial LCOS display device of the present invention can be constructed by replacing the light source 402 shown in FIG. 4 into the white light source 502 described above. In the off-axial LCOS display device of the present embodiments, the other components are same as that of the LCOS display device shown in FIG. 4 except for the light source 402. Accordingly, it is noted that, the white light source described above can be used in any LCOS display device, and the scope of the invention is not limited to the embodiments described above.

It is noted that, in the white light source, according to an embodiment of the present invention, the emitted white light can be composed of a plurality of monochromatic lights. The monochromatic lights are not limited to the three primary color lights including red light, green light and blue light. In the present invention, the white light can be separated into a plurality of monochromatic lights or a plurality of monochromatic lights and another white light via the beam splitter device. However, the monochromatic lights are not limited to three primary color lights including red light, green light and blue light.

Accordingly, the white light source, according to an embodiment of the present invention, has the advantages of low heat, low power consumption, low infrared and ultraviolet radiations, and is suitable for any LCOS display device such as single-panel, two-panel, three-panel, four-panel or other multi-panel LCOS display device. It is noted that, in the single-panel LCOS display device of the present invention, only one LCOS panel and one polarization device is required. However, in the conventional LCOS display device, three LCOS panels, three polarization beam splitter, and one optical combiner prism (X-cube) are required. Therefore, single-panel LCOS display device of the present invention further has the advantages of low cost, small size, light weight and high definition. In addition, the white light source of the present invention is suitable for any LCOS display device such as on-axial or off-axial LCOS display device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A liquid crystal on silicon (LCOS) display device, comprising:
a white light source, for emitting a white light;
a color separation and polarization device, disposed on a light path of the white light and adopted for separating and polarizing the white light to obtain a plurality of polarized monochromatic lights; and
a LCOS panel device, disposed on a light path of the polarized monochromatic lights and adapted for partially polarizing the polarized monochromatic lights according to an inputted image signal, wherein the partially polarized monochromatic lights are combined to obtain an output image signal.

2. The LCOS display device of claim 1, wherein the color separation and polarization device comprises a color separation device and a polarization device.

3. The LCOS display device of claim 2, wherein the color separation device is disposed on the light path of the white light and adapted for separating the white light into a plurality of monochromatic lights, and the polarization device is disposed on a light path of the monochromatic lights and adapted for polarizing each of the monochromatic lights to obtain a plurality of polarized monochromatic light.

4. The LCOS display device of claim 2, wherein the polarization device is disposed on the light path of the white light and adapted for polarizing the white light, and the color separation device is disposed on a light path of the polarized white light and adapted for separating the polarized white light into a plurality of polarized monochromatic light.

5. The LCOS display device of claim 1, wherein a part of each of the partially polarized monochromatic lights is related to a gray scale of the inputted image signal.

6. The LCOS display device of claim 2, wherein the color separation device comprises a color wheel.

7. The LCOS display device of claim 2, wherein each of the polarized monochromatic lights comprises one of three primary color lights.

8. The LCOS display device of claim 2, wherein the monochromatic lights comprise three primary color lights and another white light.

9. The LCOS display device of claim 1, wherein the LCOS panel device comprises one LCOS panel, two LCOS panels, three LCOS panels, four or more than four LCOS panels.

10. The LCOS display device of claim 9, wherein the color separation and polarization device comprises at least one color separation device and at least one polarization device, wherein a number of the color separation device and a number of the polarization device is dependent on a type of the LCOS panel device.

11. The LCOS display device of claim 1, wherein the LCOS display device comprises an on-axial LCOS display device.

12. The LCOS display device of claim 1, wherein the LCOS display device comprises an off-axial LCOS display device.

13. The LCOS display device of claim 1, wherein the white light source comprises a white light light-emitting-diode (LED) light source.

14. The LCOS display device of claim 1, wherein the white light source comprises a combination of a plurality of monochromatic LED light sources.

15. The LCOS display device of claim 1, wherein the white light source comprises a combination of three primary color LED light sources.

16. The LCOS display device of claim 1, wherein the white light source comprises a combination of a blue light LED and a yellow fluorescent dye.

17. A liquid crystal on silicon (LCOS) display device, comprising:
a plurality of monochromatic light emitting diode (LED) light sources, for emitting a plurality of monochromatic lights;
a plurality of polarization devices, wherein each of the polarization devices are disposed on a light path of each of the monochromatic lights respectively, the polarization devices are adopted for polarizing the monochromatic lights to obtain a plurality of partially polarized monochromatic lights;
a plurality of LCOS panels, wherein each of the LCOS panels are disposed on a light path of each of the polarized monochromatic lights, the LCOS panels are adapted for partially polarizing the polarized monochromatic lights according to an inputted image signal; and
an optical combiner device, for combining the partially polarized monochromatic lights to obtain an output image signal.

18. The LCOS display device of claim 17, wherein a part of each of the partially polarized monochromatic lights is related to a gray scale of the inputted image signal.

19. The LCOS display device of claim 17, wherein each of the monochromatic lights comprises one of three primary color lights.

20. The LCOS display device of claim 17, wherein the monochromatic lights comprise three primary color lights and another white light.

21. The LCOS display device of claim 17, wherein the LCOS panels comprise one LCOS panel, two LCOS panels, three LCOS panels, four or more than four LCOS panels.

22. The LCOS display device of claim 17, wherein the LCOS display device comprises an on-axial LCOS display device.

23. The LCOS display device of claim 17, wherein the LCOS display device comprises an off-axial LCOS display device.
